(19) United States
(12) Patent Application Publication
(10) Pub. No.: US 2009/0249389 A1
(43) Pub. Date: Oct. 1, 2009

(54) Method of increasing effectiveness of television advertising during a game show

(76) Inventor: Steven Jay Katz, Vernon Hills, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/079,383

(22) Filed: Mar. 26, 2008

(51) Int. Cl. H04N 7/10

(52) U.S. Cl. 725/32

(57) ABSTRACT

A method for increasing the effectiveness of advertising content during a broadcast includes forming questions based on the advertising content of the broadcast. The broadcast may include a home participation aspect, and the questions may be presented to listeners or viewers who seek to participate in a home participation aspect of the broadcast. Prizes, continued participation, or other rewards may be provided to listeners or viewers who answer correctly.

### FIELD OF THE INVENTION

This invention is generally related to increasing the effectiveness of broadcast advertising, and in particular, advertising aired during television game and reality shows. More particularly, the advertising becomes more effective when incorporated into the content of a home participation feature, which allows listeners or viewers to participate in the television show via the Internet, voice telephone system, cellular text messaging or other communication means.

### BACKGROUND OF THE INVENTION

Presently, a wide variety of television game shows have home participation features. In some cases, the outcome of the show is determined by a viewing audience vote conducted either over the Internet, by a text message sent from a cellular phone, or by calling a specific telephone number. In other cases, the viewing audience plays a separate game based on elements of the broadcast game. The separate game is sometimes played either over the Internet or by a text message sent from a cellular phone, as by calling a specified phone number, and one or more home contestants may win a prize based on the results, or sometimes resolved by lottery. In yet other cases, the viewing audience plays along with a televised quiz-type game show, typically over the Internet, by answering questions simultaneously with the television contestants for personal amusement or prizes. A common theme is that home audience participation increases the appeal of the show and hence the size of the viewing audience (a/k/a “ratings”) of the show, making advertising time slots on the show more valuable. For example, one show, Lingo, has a home participation feature which allows viewers to solve word puzzles on their home computers over the Internet simultaneously with the television broadcast of the game show contest. In some cases home participation is free, in other cases the viewer is charged, typically by a phone toll charged to the caller or sender of the text message. One show, American Idol, has a home participation feature which allows viewers to vote for their favorite contestant which show initially charged the participant a monetary fee to vote, and thereafter did not charge the viewer a fee to vote.

Recently, economic models which charged a toll charge to enter a lottery-type home participation game have generated controversy regarding whether such lotteries are a method of illegal gambling. The controversy has resulted in a decline in revenue for the operators of such lotteries who have ceased to practice the toll charge model. Additionally, economic models which charged a toll charge to vote on the outcome have fallen into disfavor due to the preference of many viewers to participate in an activity that does not require a monetary payment, and concern regarding the allegations of illegal gambling made against toll charge lottery-type games.

There is no current home participation feature which increases the degree of attention a viewer pays to the advertisements during the show (as opposed to the show itself). Advertisers are well aware that commercials are used by viewers as either mental or physical breaks from the broadcast, and advertisers expend significant funds in an attempt to retain the viewers' attention during their advertisements.

Accordingly, there is a demand for home participation features of game and reality shows which increase viewer awareness of the advertising content aired during the game or reality show and act as a substitute for the toll charge model which has fallen into disfavor.

### SUMMARY OF THE INVENTION

The present invention in one form is a home participation feature conducted, preferably over the Internet, voice telephone system, or by cellular text messaging, whereby a home viewer or listener who desires to participate in the home participation feature qualifies most preferably by correctly responding to a question relating to the advertising content aired during the show. “Advertising content” or “commercials” as used herein are those advertising messages that are not part of the show's content and promote a party's products or services or convey information (such as paid advertisements aired in typical thirty or sixty second increments). Viewers desiring to participate will therefore pay closer attention to the advertising content in order to obtain the opportunity to participate in the home participation feature, thus increasing the value of advertising on television shows practicing the invention. Additional aspects of the invention are methods to create revenue streams in addition to increased advertising rates.

There is no current home participation feature of a television game or reality show which requires awareness of commercials broadcast during the television show. Additionally, there is no current home participation feature of a television game or reality show which creates additional revenue streams other than via a toll charge for telephone or cellular text message participation. It is believed that by incorporating questions about the commercials during a television show into the home participation features, audience members will pay more attention to a broadcast's commercials, which would enhance the value of the advertising time on a show.

It will be understood that television is not the only medium for the invention. An Internet embodiment, for example, would be another application, as would radio.

In one embodiment, a method for increasing a person's attention to the advertising content of a broadcast includes providing a broadcast that is receivable by a plurality of individuals who are not physically present at the origination point of the broadcast and providing advertising content on said broadcast. A communication link may be established through which some of said individuals can participate in an aspect of the broadcast in the course of the broadcast. One or more questions drawn from the advertising content of the broadcast may be formulated and asked of an individual who is linked to an aspect of the broadcast and is a potential qualifier to participate in an aspect of the broadcast.

The method may include determining whether the potential qualifier answered the question correctly and acting upon that determination. A determination that a potential qualifier answered correctly may qualify the potential qualifier for a reward, such as a prize or continued participation in an aspect of the broadcast. The broadcast could be a television, radio, Internet, other broadcast. Part of the broadcast may be a game show, and a communication link may be established with a live aspect of a game show.

Accordingly, there is a demand for play at home or home participation features of television game or reality shows, which increase the listener's or the viewer's awareness of commercials to commensurately increase the value of advertising time during such shows and create additional revenue streams.

### DETAILED DESCRIPTION OF EMBODIMENTS OF THE INVENTION

The present invention, in one aspect, includes a television reality game show where the home audience votes to determine the outcome of the game. To be eligible to vote, a home audience member must correctly answer a question related to the content of a commercial during the show itself. For example, a home audience member may seek to vote on his or her favorite contestant over the Internet by logging onto the television show's website. Prior to voting, the audience member must answer a simple question regarding the advertisements airing during the television broadcast. For example, if during the show a particular auto manufacturer aired an advertisement stressing the safety of their product, the entry question may be: “Which car company has a 5 star crash rating on all of its vehicles?” By giving the correct answer, the home participant will be permitted to cast his or her vote on the outcome of the show. The question may be asked with a multiple choice answer, or alternatively with a fill-in-the-blank type answer.

If the participant gives the wrong answer, one variation would then provide the correct answer and subsequently permit the home audience member to vote. In another variation, the home audience member who erroneously answers the question must attempt to re-qualify by a second separate attempt, or the home audience member who misses the answer is disqualified.

Similarly, if the home audience member desires to participate via cellular or conventional telephone, the participation question may be asked verbally seeking either verbal, text or multiple choice responses. If the home audience member desires to participate via cellular text messaging, the participation question may be asked with a reply text message, with the correct answer permitting the audience member to log his or her vote via a text reply. In another aspect, the eligibility to enter a lottery type game, for example, the Lucky Case Game played during the airing of Deal or No Deal, could be dependent on correctly answering the commercial content question.

The present invention, in another aspect, includes a television quiz game show where the home audience plays along simultaneously with the contestants over the Internet for personal amusement. For example, the television contestant is asked a multiple choice question while the question is played simultaneously by home viewers over the Internet, who are presented the same question with the same visual presentation as the actual television contestant. Hence, the home audience member may match wits against the actual television contestant. To be eligible to play the home participation feature, a home audience member must correctly answer a qualifying question related to the content of a commercial which aired during the show itself. The qualifying question may be in the same format as the show and may be asked by the show announcer, either over the broadcast or over the Internet.

A home audience member may play the first round of a multiple choice quiz show television game simultaneously with the television contestant to match wits. After the first commercial break, to continue to play, the home player may be asked a multiple choice question in the same format as the television game, such as: “How many cars made by Acme Motors have a 5 star crash rating?: a) 3; b) 4; c) 5 or d) 10?” By providing the correct answer, the player can continue to play along. Alternatively, if the Internet version tracks a score for the home player, additional points may be awarded for a correct answer. Similarly, depending on the content of the game, home play could be conducted via a voice telephone system or via cellular text messaging.

In all of the embodiments discussed above, participation in the commercial (advertising content) aspect of the game is a gateway to participation (in the case of voting and also in the case of a lottery type parallel game), or continued participation (in the case of a quiz show). In all embodiments of the invention, additional incentives could be used to overcome any resistance to participate in the commercial aspect of the game, beyond eligibility. For example, in a quiz show type game, a prize could be awarded to the home player with the highest score, where continued participation is dependent upon correctly answering the questions directed toward advertising content. As an additional example, in the voting-type home participation embodiment, a prize could be awarded at random to a home participant who has successfully voted by answering the commercial question. Alternatively, rather than being a gateway to vote, providing the correct answer to the commercial question may be required for eligibility in a lottery. As an additional example, in the lottery-type home participation game, the prize could be increased if the lottery winner has correctly answered the commercial question.

In another embodiment, questions regarding the advertising content are used instead of or in addition to the other home participation feature content, resulting in an increased score for correct answers. Thus a player may improve his or her score in the game by correctly answering the questions regarding the advertising content. This embodiment could also be combined with the “answer questions about commercials to qualify” embodiment where some aspect of the questions and answers about the commercials is used to qualify a player while some other aspects (which may or may not overlap) could be applied to the player's score.

Given any method of utilizing the invention, the value of the advertising time on the show is increased by incentivizing the home audience to pay attention to the commercials rather than using the commercial breaks as time for mental or physical breaks from the television game show. Hence, television networks can charge increased fees for advertising on the television show.

Additionally, the invention leads to new revenue models, for which are also claims of this invention. For example, an advertiser could be charged an additional fee to have its product or service be the subject of the commercial question, particularly if the “correct” answer is provided to a home participant who does not provide the correct response. As an additional example, an advertiser could be required to furnish a prize, either to the television game show or to a randomly selected home participant or to the home participant with the highest score (as well as a be charged an additional advertising fee).

Various embodiments in accordance with the present invention have been described herein. It will be appreciated, however, that those skilled in the art will understand that changes and modifications may be made to these embodiments, as well as combinations of the various embodiments, without departing from the true scope and spirit of the present invention, which is defined by the following claims.

What is claimed is:

1. A method for increasing a person's attention to one or more commercials of a broadcast comprising the steps of:
providing a broadcast which a plurality of individuals who are not physically present at the origination point of the broadcast may receive;
providing at least one commercial on said broadcast;
establishing a communication link through which at least some of said individuals can participate in an aspect of said broadcast in the course of said broadcast;
formulating one or more questions drawn from said commercial;
asking at least one said question of an individual who has linked to said aspect of said broadcast as a potential qualifier;
determining whether said potential qualifier has answered said question correctly;
and acting upon said determination.

2. The method of claim 1 wherein said determination is to qualify said potential qualifier for a reward in the event of a correct answer.

3. The method of claim 2 wherein said reward is further participation in said broadcast.

4. The method of claim 2 wherein said reward is a prize.

5. The method of claim 1 wherein said broadcast is a game show.

6. The method of claim 5 wherein said individual is linked to a live game show broadcast.

7. The method of claim 2 wherein said broadcast is one of a television, Internet, radio, or telephone broadcast.
